(19) United States
(12) Patent Application Publication
(10) Pub. No.: US 2024/0302678 A1
(43) Pub. Date: Sep. 12, 2024

(54) METHOD FOR CALCULATING A SPECTACLE LENS ON THE BASIS OF A BIG DATA APPROACH AND MACHINE LEARNING

(71) Applicant: Rodenstock GmbH, Muenchen (DE)

(72) Inventors: Gregor Esser, Muenchen (DE); Adam Muschielok, Muenchen (DE); Helmut Altheimer, Baisweil-Lauchdorf (DE); Wolfgang Becken, Neuried (DE); Anne Seidemann, Muenchen (DE); Patrick Kerner, Oberhaching (DE); Martin Zimmermann, Erdweg-Kleinberghofen (DE); Lukas Gromann, Freising (DE); Leonhard Schmid, Diessen Am Ammersee (DE); Dietmar Uttenweiler, Icking (DE); Stephan Trumm, Muenchen (DE)

(21) Appl. No.: 18/251,566

(22) PCT Filed: Nov. 2, 2021
(86) PCT No.: PCT/EP2021/080370

§ 371 Date: Aug. 21, 2023

(30) Foreign Application Priority Data
Nov. 3, 2020 (DE) 102020128958.8

(51) Int. Cl. G02C 7/02

(52) U.S. Cl. CPC G02C 7/028; G02C 7/027

(57) ABSTRACT

A computer-implemented method for determining biometric data of an eye and a corresponding method for manufacturing spectacle lenses taking into account the biometric data determined. The method includes: providing individual standard data of a user, the standard data including prescription data including a distance prescription and/or a near prescription of at least one eye of a user; and calculating individual additional data including at least one individual biometric parameter of the at least one eye of the user based on the individual standard data and using a statistical model describing a relation between the standard data and the additional data, wherein the statistical model has been derived using statistical analysis of a training data set with a plurality of reference data sets, each of the reference data sets including standard data and additional data associated with the standard data.

### Technical Field

The present invention relates to a computer-implemented method for determining biometric data of an eye and to a corresponding method for manufacturing spectacle lenses taking into account the biometric data determined. Furthermore, the invention relates to corresponding computer program products and devices.

### Background

In the calculation of spectacle lenses, in particular progressive spectacle lenses, the biometrics of the eye of the spectacle wearer can be taken into account, as described in document U.S. Pat. No. 9,910,294 B2, for example. These biometric spectacle lenses offer great advantages, since the quality of the imaging is no longer evaluated at the vertex sphere, a virtual point of a simple model, but where the imaging actually takes place: on the retina of the eye. Thus, interactions between the individual aberrations, which arise during refraction and propagation through the media of the eye, are also taken into account.

The disadvantage of this method, however, is that extensive measurements with complex equipment and devices are necessary. This leads to great effort and high costs. As a result, the advantages of high-quality biometric spectacle lenses are only available to a relatively small proportion of those with visual defects.

### SUMMARY

It is an object of the present invention to make extensive use of the advantages of biometric spectacle lenses without having the disadvantages of the complex measurement.

This object is achieved by a computer-implemented method for determining biometric data of an eye, a corresponding device, and a corresponding computer program product, as well as a method and a corresponding device for manufacturing a spectacle lens with the features specified in the respective independent claims.

The present invention is based on the surprising finding that it is possible to determine or predict individual biometric parameters of at least one of the eyes of a user with sufficient accuracy and precision using standard values of the user's eye determined as part of a routine refraction determination. It is therefore possible to calculate and manufacture individual biometric spectacle lenses with high imaging quality and wearing comfort, without a complex and cost-intensive measurement of the additional biometric data being necessary for this.

A first aspect of the invention relates to a computer-implemented method for determining individual biometric parameters of at least one of the eyes of a user. The method comprises:
providing individual standard data of the user, the standard data including prescription data of at least one of the eyes of a user;
calculating individual additional data including at least one individual biometric parameter of at least one eye of the user based on the individual standard data and using a statistical model describing a relation between standard data and additional data,
wherein the statistical model has been derived using statistical analysis of a training data set with a plurality of reference data sets, each of the reference data sets including standard data and additional data associated with the standard data.

The method can also comprise providing the statistical model describing the relation between standard data and additional data.

Furthermore, the method can comprise providing the training data set and deriving the statistical model using statistical analysis of the training data set. Deriving the statistical model can comprise, for example, training an original (non-trained) model using the training data set. For example, the model can comprise several model parameters altered or adapted during training with the training data set.

The term “providing” within the meaning of the present application includes “specifying”, “transmitting”, “obtaining”, “reading out”, “retrieving from a memory, a database and/or a table”, “receiving”, etc.

The term “determining” within the meaning of the present application also includes “specifying”, “calculating”, “identifying”, “predicting”, etc.

### Standard Data

Standard data (basic data) is data of at least one of the eyes of a user and possibly other data that is recorded in connection with an order for spectacles (for example by an optician or an ophthalmologist). For example, the standard data can include data that is normally always recorded in connection with an order for spectacles, such as prescription data. The standard data can also include data that is usually optionally recorded or measured in connection with an order for spectacles, such as the higher-order aberrations of at least one of the eyes of a user, etc. This data can then be used to determine further supplementary data (additional data).

For example, the standard data can include data that has been recorded with a first measuring device or a first measurement method. Additional data can be calculated on the basis of this data, which cannot be determined or measured with the first measuring device or with the first measurement method. Alternatively or in addition, the additional data can include data that can be determined or measured with the first measuring device or the first measurement method, but not with sufficient quality (for example not with sufficient accuracy, precision and/or repeatability).

For example, in the determination of at least part of the standard data there can be available a measuring device that allows determining part of the biometric parameters of at least one of the eyes of a user to be taken into account when calculating an individual biometric spectacle lens. The data recorded with this measuring device can then be used to determine additional individual biometric parameters that cannot be determined with this measuring device. The first measuring device can be an aberrometer, for example, which makes it possible to determine the aberrations of the eye, but not the aberrations of the cornea (which are measured with a topographer, for example,) and/or the anterior chamber depth (which is measured with a Scheimpflug camera, for example). The method can be used to determine further biometric data, such as aberration of the cornea and/or the anterior chamber depth, based on the aberration data of the eye recorded with the aberrometer. If a topographer and/or a Scheimpflug camera is available, the corresponding measurement data can be used to determine the aberrations of the eye.

As described above, the method can also be used when data not only cannot be determined or measured (because the appropriate measuring devices are not available, for example), but also when the corresponding data can only be determined or measured in poor or insufficient quality. For example, the standard data can include data that has been measured with a first (for example simple) measuring device or measurement method that delivers data with a low or insufficient quality. The data recorded with the first measuring device or with the first measurement method can be used to determine additional data having a higher quality. For example, the additional data can correspond to data that has been recorded or can be measured with a second, more precise measuring device/measuring device type or with a second measurement method.

The standard data includes at least the prescription data. The prescription data includes a distance prescription (i.e., the refraction data when looking at a distant distance, e.g., at infinity) and/or a near prescription (i.e., the refraction data when looking at a near distance, e.g., at a reading distance). The distance prescription of at least one of the eyes of a user is composed of the parameters sphere (Sph), cylinder (Cyl), and axis, or of variables derived therefrom, such as the components M (spherical equivalent), J0 (ortho-astigmatism), and J45 (oblique astigmatism) of the power vector of the distance prescription. The near prescription is also composed of the variables sphere (Sph), cylinder (Cyl), and axis of at least one of the eyes of a user, or of variables derived therefrom, such as the components M, J0 and J45 of the power vector of the near prescription. The prescription data can also include the addition, for example in the case of progressive lenses and multifocal lenses.

The distance prescription, the addition and/or the near prescription can be determined using subjective refraction, for example. It is also possible to determine the distance prescription, the addition and/or the near prescription using objective refraction or using a combination of objective and subjective refraction.

The subjective refraction determination is a method of refraction determination in which the visual impression subjectively felt by the user is taken into account. Usually, different refractive lenses are placed in front of the user, with the user of the spectacle lens notifying the refractionist of an improvement or a deterioration in the visual impression when the optical properties of the refractive lens in front change.

In the case of an objective refraction, however, no feedback from the user is taken into account. The objective refraction is carried out solely using an apparatus arrangement and can also record the refractive properties and the geometry of the eyeball. The objective refraction can be performed using various devices such as refractometers, aberrometers, wavefront scanners, etc.

Optionally, the standard data can include at least one of the following parameters:
pupillary distance PD; and
pupil diameter.

Pupillary distance and pupil diameter can be determined using conventional measurement methods.

Furthermore, the standard data can optionally include at least part of the following data, the data having been recorded using a first measurement method or measuring device:
lower and/or higher order aberrations of the eye, such as sphere (Sph), cylinder (Cyl), axis (or M, J0, J45), coma, trefoil, secondary astigmatism, spherical aberration, and/or other aberrations; and/or
lower and higher order aberrations of the cornea, such as sphere (Sph), cylinder (Cyl), axis (or M, J0, J45), coma, trefoil, secondary astigmatism, spherical aberration and/or other aberrations; and/or
physical dimensions of the eye, such as anterior chamber depth, eye length, etc.; and/or
eye lens data, for example including lower and higher order aberrations of the eye lens (such as sphere (Sph), cylinder (Cyl), axis (or M, J0, J45), coma, trefoil, secondary astigmatism, spherical aberration and/or other aberrations); and/or structure and/or physical dimensions of the eye lens, such as curvatures and/or thickness; and/or
pupil sizes during distance vision and near vision and/or pupil sizes under mesopic and photopic conditions.

Furthermore, the standard data can also optionally include the following additional parameters: age, gender, ethnicity, place of order, body height, intraocular pressure, blood values, anamnesis data or medical record (e.g. possibly diabetes), images of the retina, values of eye pressure, data of the anterior segment of the eye (chamber angle) and/or data of the old spectacle lens.

### Additional Data

Additional data is biometric data of at least one of the eyes of a user, which are determined (for example by an optician) in connection with an order for spectacles. The additional data can be data, for example, which is usually determined optionally (for example by the optician) in connection with an order for spectacles. As described above, the additional data and the standard data can at least partially include the same parameters (such as aberrations in at least one of the eyes of a user, etc.), with the parameters included in the additional data and the parameters included in the standard data being recordable using different measurement methods or measuring devices.

For example, the additional data can include data that is measured with an aberrometer, a topographer, a Scheimpflug camera, an OCT (i.e. an optical coherence tomograph or a method of optical coherence tomography), a biometer, and/or another measuring device or that have been or can be recorded using another method of objective refraction.

The additional data can include, for example, the following biometric data or parameters of at least one of the eyes of a user:
lower and/or higher order aberrations of the eye, such as sphere (Sph), cylinder (Cyl), axis (or M, J0, J45), coma, trefoil, secondary astigmatism, spherical aberration, and/or other aberrations; and/or
lower and higher order aberrations of the cornea, such as sphere (Sph), cylinder (Cyl), axis (or M, J0, J45), coma, trefoil, secondary astigmatism, spherical aberration and/or other aberrations; and/or
physical dimensions of the eye, such as anterior chamber depth, eye length, etc.; and/or
eye lens data, for example including lower and higher order aberrations of the eye lens (such as sphere (Sph), cylinder (Cyl), axis (or M, J0, J45), coma, trefoil, secondary astigmatism, spherical aberration and/or other aberrations); and/or structure and/or physical dimensions of the eye lens, such as curvatures and/or thickness; and/or
pupil sizes during distance vision and near vision and/or pupil sizes under mesopic and photopic conditions.

The additional data preferably includes at least part of the following data or parameters: the higher order aberrations of the eye (such as coma, trefoil, secondary astigmatism, spherical aberration, etc.), the lower and higher order aberrations of the cornea (sphere (Sph), cylinder (Cyl), axis (or M, J0, J45), coma, trefoil, secondary astigmatism, spherical aberration, etc.), the anterior chamber depth, the pupil sizes in the distance and near and/or under mesopic and photopic conditions.

The additional data in the reference data sets may be data that has been recorded or measured for earlier orders of biometric spectacle lenses in addition to the standard data, for example with an aberrometer, a topographer, a Scheimpflug camera, an OCT, a biometer and/or another measuring device.

The individual additional data specified based on a user's standard individual data and the additional data determined using the statistical model may, but need not, be the same type of additional data included in the reference data sets and used to derive the statistical model.

### Statistical Model

The statistical model can be any statistical model that is derived from an existing data set (training data set) using statistical methods. Exemplary statistical methods are regression (such as linear regression, nonlinear regression, nonlinear regression with an attention mechanism, nonlinear multi-task regression, nonparametric or semiparametric regression, etc.), classification methods, and other machine learning methods. Machine learning algorithms are described, for example, in Jeremy Watt, Reza Borhani, Aggelos Katsaggelos: Machine Learning Refined: Foundations, Algorithms, and Applications, Cambridge University Press, 2020.

The statistical model receives at least part of the individual standard data and/or variables derived therefrom as input variables and uses them to calculate at least part of the additional individual biometric parameters or additional data. The relation between standard data and additional data specified by the statistical model can be a linear or nonlinear relation. Furthermore, the relation can be multi-parametric.

Exemplary statistical models are linear or nonlinear regression models. For example, neural networks, which also include deep neural networks, can be used as nonlinear regression models. It is also possible to use other nonlinear regression models known from the field of machine learning. The regression models, such as the neural network, can be trained using the training data set provided.

The statistical model can also be a combination of several statistical models of different types, for example a combination of a linear regression model, a nonlinear regression model (such as a neural network), a classification model and/or another statistical model.

The statistical model derived from the training data set can be stored in a suitable storage device such as a database, calculator, computational or data cloud. At least part of the training data set used for the derivation can be stored together with the statistical model.

The statistical model derived from a training data set can also be checked and/or modified continuously or at regular intervals, for example on the basis of new reference data sets. Accordingly, the method may include modifying the statistical model.

### Neural Networks as Statistical Models

If the statistical model contains a neural network or if it consists of one, the input layer of the neural network is filled with at least part of the standard data and/or auxiliary variables calculated therefrom. The output layer outputs values for at least one additional parameter or at least part of the additional data. The neural network can preferably also contain one or more hidden layers in addition to an input and an output layer.

During training of an original, untrained neural network, the weights are changed using appropriate learning algorithms. The trained neural network specifies the relation between standard data and additional data.

The structure of the neural network (such as the number and types of layers, number and types of neurons in the different layers, the way the layers and neurons are linked to one another, etc.) and the learning algorithms can be different.

### Training Data Set

The statistical model, which describes the relation between standard data and additional data, is derived using statistical methods on the basis of a training data set with a plurality of individual data sets (reference data sets). Each of the reference data sets can include, for example, standard data and the additional data of a specific user determined using suitable measurement methods. The different reference data sets in the training data set can preferably include the data (standard data and additional data) of a plurality of different users (reference users).

The additional data included in the reference data sets may include biometric parameters that are not included in the standard data assigned to the additional data. It is also possible for the additional data included in the reference data sets to include biometric parameters that are included in the standard data assigned to the additional data, but are of lower quality. For example, the values of the standard data and the additional data assigned to this standard data can have been recorded using different measurement methods and/or measuring devices.

To this end, existing orders for biometric spectacle lenses can be used to train a neural network or another statistical model with the data sets. In the case of a new standard order, the additional measurement data (additional data) can be calculated or forecast using the trained statistical model and based on the individual standard parameters included in the new order. Thus, biometric spectacle lenses can be calculated based on individual standard parameters and additional data calculated therefrom using the neural network or other statistical models.

The number of reference data sets can vary. For example, more than 10, 100, 1,000, 10,000, 100,000, or 1,000,000 reference data sets may be used. The reference data sets preferably cover a large, preferably the entire, range in which spectacle lenses can be ordered later on. For example, the reference data sets can cover the range of refraction values, for example −20 dpt to +20 dpt for sphere and −8 dpt to +8 dpt for cylinder.

Furthermore, the method for determining individual biometric parameters of at least one of the eyes of a user can comprise transmitting the individual standard data and the calculated individual additional data to an external entity, such as a manufacturer of ophthalmic lenses, a manufacturing unit, a manufacturing device, etc.

A second aspect of the invention relates to a method for manufacturing a spectacle lens, comprising:
providing the user's individual standard data, the standard data including a distance prescription of at least one of the eyes of a user;
determining individual biometric parameters of at least one of the eyes of a user based on the provided individual standard data of the user according to the method according to one of the above aspects;
calculating the spectacle lens based on the individual standard data provided and the individual biometric parameters determined.

For example, the spectacle lens can be calculated using the method described in U.S. Pat. No. 9,910,294 B2 or using another known method in which individual biometric parameters are taken into account when calculating the spectacle lens.

The method can also comprise manufacturing the calculated spectacle lens. The spectacle lens may be a single-vision spectacle lens, a multifocal spectacle lens or a progressive spectacle lens.

A third aspect of the invention relates to a computer-implemented method for determining a statistical model, the method comprising:
providing a training data set with a plurality of reference data sets, each of the reference data sets including standard data and additional data associated with the standard data;
deriving, using statistical analysis of the training data set, a statistical model describing a relation between the standard data and the additional data,
storing the statistical model in a storage device.

A fourth aspect of the invention relates to a computer program product which, when loaded into and executed on the memory of a computer, causes the computer to carry out a method according to one the above aspects.

With regard to the methods and computer program products described above, the aforementioned preferred embodiments and the aforementioned advantages apply analogously.

The method according to one of the above aspects can be carried out using a correspondingly designed device.

A fifth aspect of the invention relates to a device for determining individual biometric parameters of at least one of the eyes of a user, the device comprising a calculating device designed to carry out the above-described method for determining individual biometric parameters.

The calculating device can preferably comprise:
a standard data input interface for providing individual standard data of the user, the standard data including prescription data (such as distance prescription and/or near prescription and possibly addition) of at least one of the eyes of a user;
an additional data calculating device for calculating individual additional data, comprising at least one individual biometric parameter of the at least one eye of the user, the calculation taking place based on the individual standard data and using a statistical model, the statistical model being derived using statistical analysis of a training data set with a plurality of reference data sets, each of the reference data sets including standard data and additional data associated with the standard data.

Furthermore, the device can comprise a model input interface for providing the statistical model. For example, the statistical model may be stored in a device, such as a database, a calculator, and/or a data or calculator cloud. Furthermore, the device can provide a training data set input interface for providing the training data set; and a model calculating device for deriving or calculating the statistical model using statistical analysis of the training data set. The statistical model can be derived or calculated by training an original (untrained) model using the training data set, for example.

A sixth aspect of the invention relates to a device for manufacturing a spectacle lens, comprising:
a device for determining individual biometric parameters of at least one of the eyes of a user according to the fifth aspect;
a lens calculating device designed to calculate the spectacle lens based on the individual standard data provided and the calculated individual biometric parameters.

The manufacturing device can also comprise a manufacturing device for manufacturing the calculated spectacle lens.

The above-mentioned devices for providing, determining, specifying or calculating data (such as (individual) standard data, (individual) additional data, statistical models, model parameters, weighings, etc.) can be realized by suitably configured or programmed data processing devices (in particular specialized hardware modules, computers or computer systems, such as computer or data clouds) with appropriate computing units, electronic interfaces, storage and data transmission units. The devices may further comprise at least a preferably interactive graphical user interface (GUI) allowing a user to view and/or input and/or modify data.

The devices mentioned above can also have suitable interfaces that enable data (such as training data sets, reference data sets, (individual) standard data, (individual) additional data, etc.) to be transmitted, input and/or read out. The devices can also include at least one storage unit, for example in the form of a database, which stores the data used.

The manufacturing device can comprise at least one CNC-controlled machine for the direct processing of a blank according to the determined optimization specifications, for example. Alternatively, the spectacle lens can be manufactured using a casting process. The finished spectacle lens can have a first simple spherical or rotationally symmetric aspherical surface and a second individual surface calculated as a function of the individual standard data and the calculated individual additional data. The simple spherical or rotationally symmetric aspheric surface may be the front surface (i.e., the object-side surface) of the spectacle lens. However, it is of course possible to arrange the individual surface as the front surface of the spectacle lens. Both surfaces of the spectacle lens can also be calculated individually.

A further aspect of the invention relates to a spectacle lens manufactured according to the manufacturing method described above. Furthermore, the invention offers a use of a spectacle lens manufactured according to the manufacturing method described above in a predetermined average or ideal or individual position of wear of the spectacle lens in front of the eyes of a specific user for correcting a user's visual defect.

### BRIEF DESCRIPTION OF THE DRAWINGS

In the following, preferred embodiments of the present invention will be described by way of example with reference to accompanying figures. Individual elements of the described embodiments are not limited to the respective embodiment. Rather, elements of the embodiments can be combined with one another as desired and new embodiments can be created thereby. The figures show:

FIG. 1 an exemplary method for determining individual biometric data of at least one of the eyes of a user and calculating a spectacle lens;

FIG. 2 an exemplary reference data set;

FIG. 3 an exemplary linear regression model;

FIG. 4 an exemplary nonlinear regression model;

FIG. 5 an exemplary nonlinear regression model with an attention mechanism;

FIG. 6 an exemplary multi-task nonlinear regression model;

FIG. 7A the spherical equivalent M [in Dpt] of the cornea as a function of the pupil diameter [in mm];

FIG. 7B the component J0 [in Dpt] of the power vector of the cornea as a function of the subjective ortho-astigmatism [in Dpt] included in the standard data;

FIG. 7C the component J45 [in Dpt] of the power vector of the cornea as a function of the subjective oblique astigmatism J45 [in Dpt] included in the standard data;

FIG. 8A the eye length as a function of the subjective spherical equivalent M [in Dpt] included in the standard data;

FIG. 8B the anterior chamber depth as a function of the subjective spherical equivalent M [in Dpt] included in the standard data;

FIG. 9 different biometric additional parameters of the right eye of a user in tabular form;

FIG. 10 different additional biometric parameters of a user's left eye in tabular form;

FIG. 11 the difference in the maximum peripheral astigmatism in the eye for a spectacle lens calculated using a method according to an example of the invention, and for a conventional spectacle lens without using biometric data or using biometric standard parameters as represented by the Gullstrand eye;

FIG. 12 the percentage difference in the change in refractive power for a spectacle lens calculated using a method according to an example of the invention, and for a conventional spectacle lens without using biometric data or using biometric standard parameters as represented by the Gullstrand eye;

FIG. 13 the astigmatism in the image plane of the system spectacle lens-eye, the spectacle lens having been calculated using a method according to an example of the invention;

FIG. 14 a graphical representation of an exemplary statistical model;

FIGS. 15A to 15D exemplary predictions for the cornea topography for different standard parameters;

FIGS. 16A to 16C the deviations of predicted additional data (in this case the eye length) from actually measured data.

### DETAILED DESCRIPTION

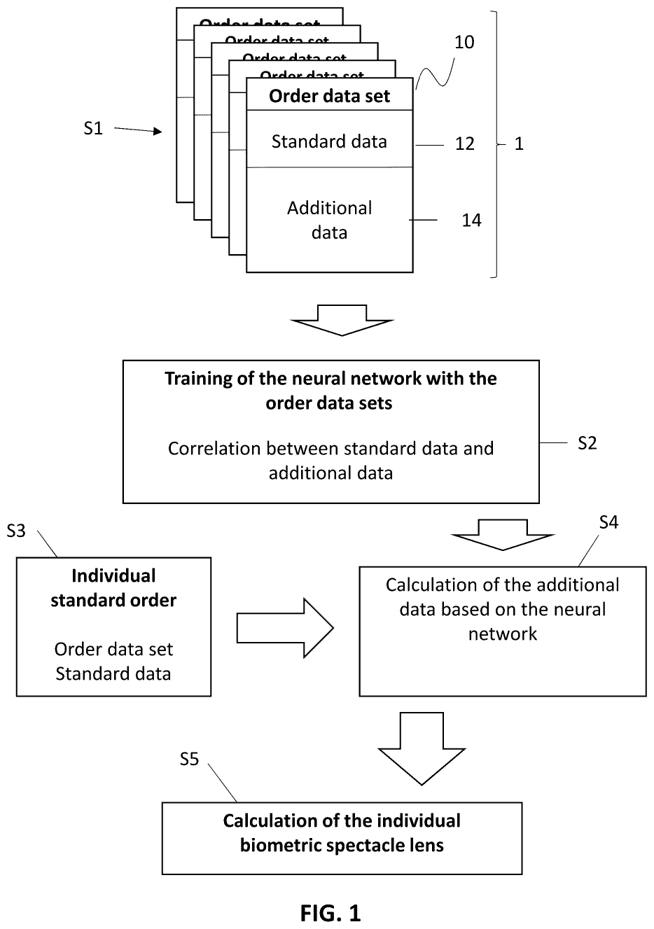

FIG. 1 shows an exemplary method for determining individual biometric parameters of at least one of the eyes of a user and for calculating a spectacle lens based on the determined individual biometric parameters. The method comprises the following steps:

Step S1: Creation of a training data set from a plurality of data sets (reference data sets) 10, each reference data set including standard data 12 and additional data 14 assigned to this standard data.

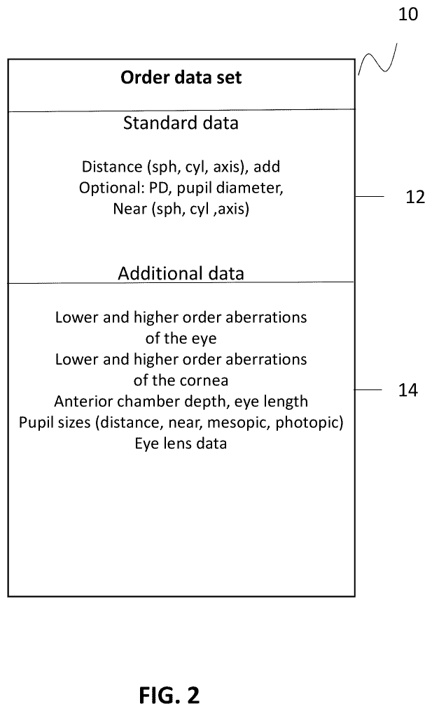

An exemplary reference data set 10 is shown in FIG. 2. The standard data 12 includes the distance prescription (Sph, Cyl, Axis or M, J0, J45) and the addition (Add) for bifocal, multifocal and progressive lenses. Optionally, the standard data further includes the pupillary distance (PD), the pupil diameter, and the near prescription (Sph, Cyl, Axis or M, J0, J45). The additional data 14 can include at least one of the following data sets, for example:
lower and higher order aberrations of the eye;
lower and higher order aberrations of the cornea;
parameters of the eye, such as anterior chamber depth, eye length;
pupil sizes (distance, near, mesopic, photopic);
eye lens data.

To form the training data set, existing orders for biometric spectacle lenses can be used, for which the additional data have been recorded using a measurement method. Exemplary measurement methods are measurements using an aberrometer, a topographer, a Scheimpflug camera, an OCT and/or a biometer.

Step S2: A relation between the standard data and the additional data is derived from the plurality of reference data sets with the aid of statistical methods. In other words, a statistical model is determined on the basis of the training data set, which describes the relation, such as the correlation(s), between standard data and additional data.

The determination of the statistical model can comprise, for example, training an originally untrained neural network with the training data set, which includes the plurality of reference data sets. The trained neural network can be tested using a test data set and/or can be validated using a validation data set. The test data set and the validation data set can each include a plurality of data sets (reference data sets) from previous orders, for example a plurality of the reference data sets shown in FIG. 2. Preferably, a reference data set included in the test data set is included in neither the validation data set nor the training data set. Similarly, a reference data set included in the validation data set is preferably included neither in the test data set nor the training data set.

Step S3: Providing an individual data set that only includes individual standard data. The individual standard data can be recorded by an optician as part of an individual order for spectacles for a user.

Step S4: Calculating individual additional data (additional data) based on the individual standard data included in the individual data set provided in step S3 and further based on the relation between standard data and additional data determined in step S2. For example, the individual standard data can be input to the trained neural network of step S2. The corresponding output data of the neural network can be used directly as the individual additional data. It is possible not to use the output data of the neural network directly, but to first subject this output data to further processing (such as checking for plausibility, smoothing, filtering, categorizing, converting, etc.).

Step S5: Calculating an individual spectacle lens based on the individual standard data included in the individual data set provided in step S3 and further based on the calculated individual additional data of step S4.

The calculation of an individual spectacle lens comprises the calculation of at least one surface of the spectacle lens based on the individual standard data and the calculated individual additional data. The surface thus calculated can be the back surface or the front surface of the spectacle lens. “Calculation of at least one surface of a spectacle lens” includes the calculation of at least a part of a surface or a piece of a surface. In other words, “calculation of at least one surface of a spectacle lens” means a calculation of at least part of the surface or calculating the entire surface.

The surface opposite the calculated surface can be a simple surface, such as a spherical, a rotationally symmetric, an aspheric, a toric, or an atoric surface. It is also possible to calculate both surfaces individually.

The individual spectacle lens can be calculated using a known method, for example using the method known from document U.S. Pat. No. 9,910,294 B2.

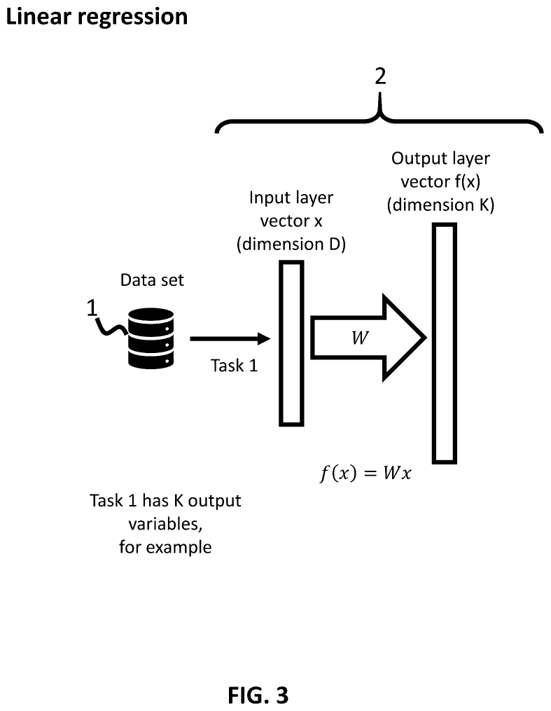

FIGS. 3 to 6 show exemplary statistical models 2 each trained on the basis of a data set 1 (training data set).

FIG. 3 shows an exemplary linear regression model with an input layer and an output layer. An output variable f (x) with K variables is calculated from a multidimensional input variable x with a dimension D (e.g. D=26):

$$f ( x ) = W x , \qquad ( 1 )$$

where W∈ [symbol] ^{K×D} denotes the weighing matrix.

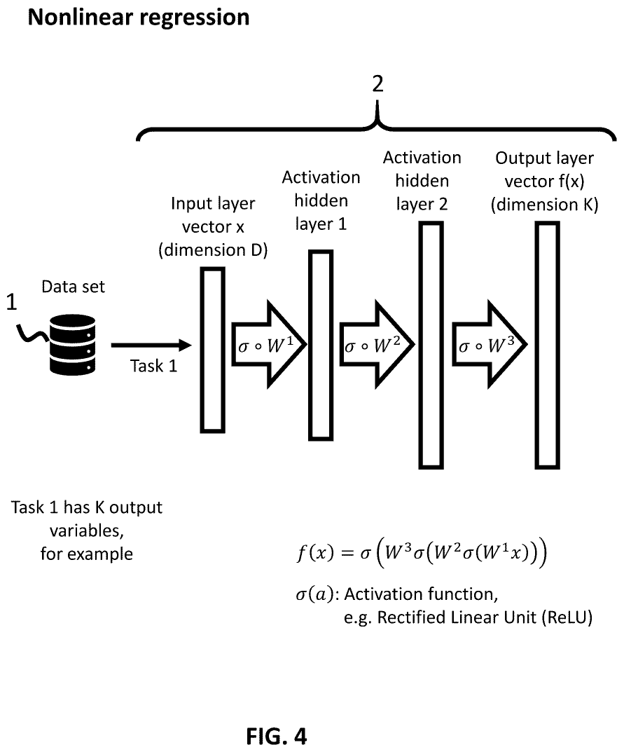

FIG. 4 shows an exemplary nonlinear regression model with an input layer, an output layer, and several hidden layers. Here, an output variable f(x) with k variables is calculated from a multidimensional input variable x with a dimension D (e.g. D=26):

$$f ( x ) = σ ( {W}^{3} σ ( {W}^{2} σ ( {W}^{1} x ) ) ) , \qquad ( 2 )$$

where:
σ(a): denotes an activation function,
for example σ(a)=max(a, 0) (Rectified Linear Unit (ReLU)); and
W¹∈ [symbol] ^{L×D}, W²∈R^{M×L} und W³∈ [symbol] ^{K×M} denote weighing matrices.

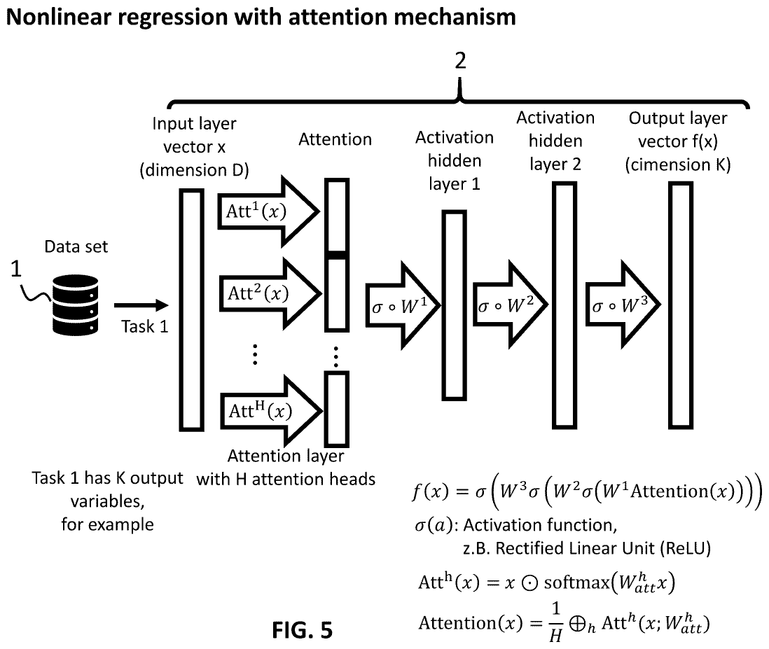

FIG. 5 shows an exemplary nonlinear regression model with an attention mechanism. The model has an input layer, an output layer, several hidden layers, and an attention layer with “H” attention heads. The following operations are performed for each of the attention heads:

$$\begin{matrix}x ⊙ softmax ( {W}_{a t t}^{h} x ) \\ softmax ( {a}_{i} ) = \frac{exp ( {a}_{i} )}{{Σ}_{j} exp ( {a}_{j} )} ,\end{matrix} \qquad ( 3 )$$

where:
Wₐₜₜ^{h}∈ [symbol] ^{D×D}, (h=1, . . . . H) denotes weighing matrices; and

h (h=1, . . . . H) denotes the h^{th} attention head.

The output f(x) is calculated by:

$$f ( x ) = σ ( {W}^{3} σ ( {W}^{2} σ ( {W}^{1} Attention ( x ) ) ) ) , \qquad ( 4 )$$

where:
σ(a) denotes an activation function (for example Rectified Linear Unit (ReLU));

$$A t {t}^{h} ( x ) = x ⊙ softmax ( {W}_{a t t}^{h} x ) ;$$

$$Attention ( x ) = \frac{1}{H} {⊕}_{h} A t {t}^{h} ( x ; {W}_{a t t}^{h} ) , h = 1 , … H ;$$

⊙ (denotes the elementwise product;
⊕ₕ denotes the concatenation of all output vectors of the individual attention heads
h=1, . . . . H; and
W¹∈ [symbol] ^{L×H·D}, W²∈ [symbol] ^{M×L} and W³∈ [symbol] ^{K×M} denote weighing matrices.

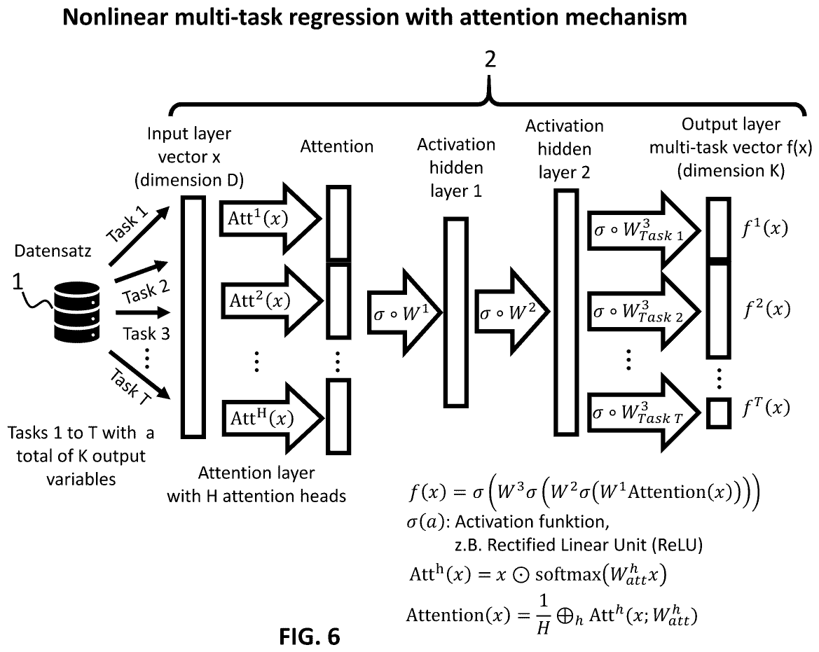

FIG. 6 shows an exemplary non-linear multi-task regression model for the processing of several tasks (tasks 1 to T). The model shown in FIG. 6 is based on the model shown in FIG. 5, which was modified for several tasks (task 1 to task T). Here, a common representation in the attention layer is used. Instead of the weighing matrix W³∈ [symbol] ^{K×M}, a separate weighing matrix W_{Trask h}², h=1 . . . , T is used for each individual task. With the help of the model, several output variables f^{t}(x), t=1, . . . , T are calculated from a multidimensional input variable x with a dimension D (e.g. D=26). The dimensions of the output variables are given by the tasks, wherein the various tasks can have different dimensions. For example, the output variable f¹ can have the dimension K₁, the output variable f² can have the dimension K₂, etc. Overall, the dimension of all output variables is the sum of the dimensions of the individual output variables Σ₁^{T} Kᵢ.

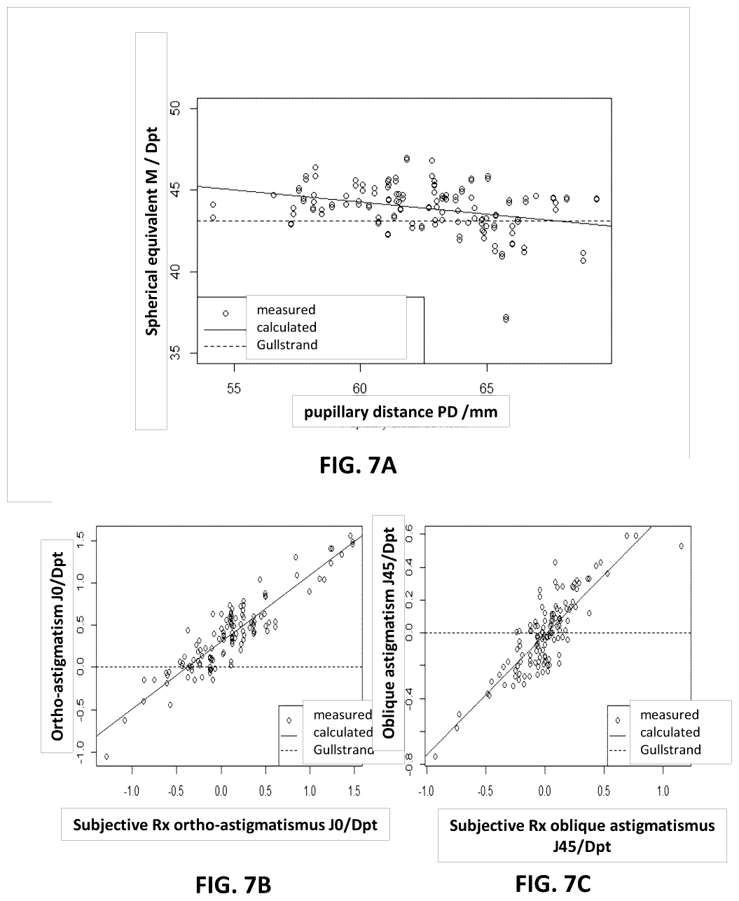

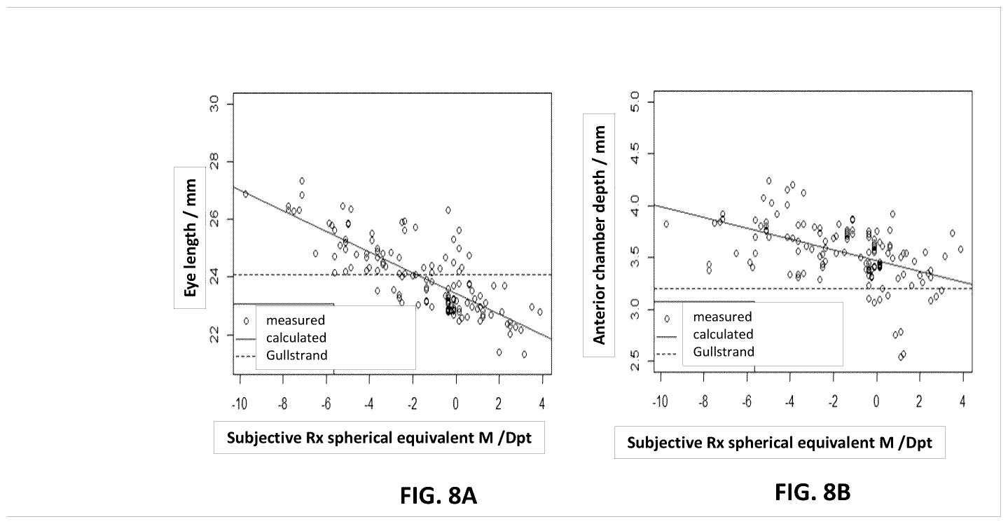

FIGS. 7 and 8 show the results for different individual biometric additional parameters (i.e. parameters included in the additional data) calculated according to the method described above using the model shown in FIG. 3 (i.e. using linear regression), compared to actually measured individual additional parameters and additional parameters according to the Gullstrand eye model. In FIGS. 7 and 8, the measured values are shown with small circles. The solid line shows the statistically determined linear relation between the respective additional parameter and the corresponding standard parameter (i.e. a parameter included in the standard data) using the above-mentioned method. The dashed line shows the parameter values according to the Gullstrand eye model.

FIG. 7 shows the results for the components of the power vector of the cornea “M” (spherical equivalent) “J0” (ortho-astigmatism) and “J45” (oblique astigmatism) of the cornea, where:

FIG. 7A shows the spherical equivalent M [in Dpt] of the cornea as a function of the pupil diameter [in mm] included in the standard data;

FIG. 7B shows the ortho-astigmatism J0 [in Dpt] of the cornea as a function of the subjective (Rx) ortho-astigmatism J0 [in Dpt] included in the standard data; and

FIG. 7C shows the oblique astigmatism J45 [in Dpt] of the cornea as a function of the subjective (Rx) oblique astigmatism J45 [in Dpt] included in the standard data.

FIG. 8 shows the eye length (FIG. 8A) and the anterior chamber depth (FIG. 8B), each as a function of the subjective (Rx) spherical equivalent M [in Dpt] included in the standard data.

The subjective (Rx) spherical equivalent M, the subjective (Rx) ortho-astigmatism J0, and the subjective oblique astigmatism J45 are the components of the power vector of the distance prescription, which was determined using subjective refraction. The distance prescription is part of the standard data.

As can be seen from FIGS. 7 and 8, the values determined using the method described above for the additional biometric parameters spherical equivalent M of the cornea, ortho-astigmatism J0 of the cornea, oblique astigmatism J45 of the cornea, eye length, and anterior chamber depth are very close to the values determined by complex measurement methods.

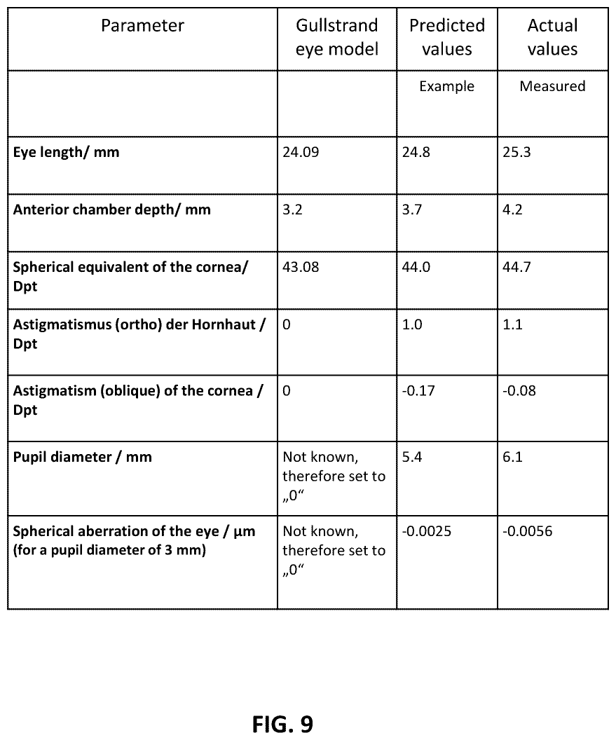

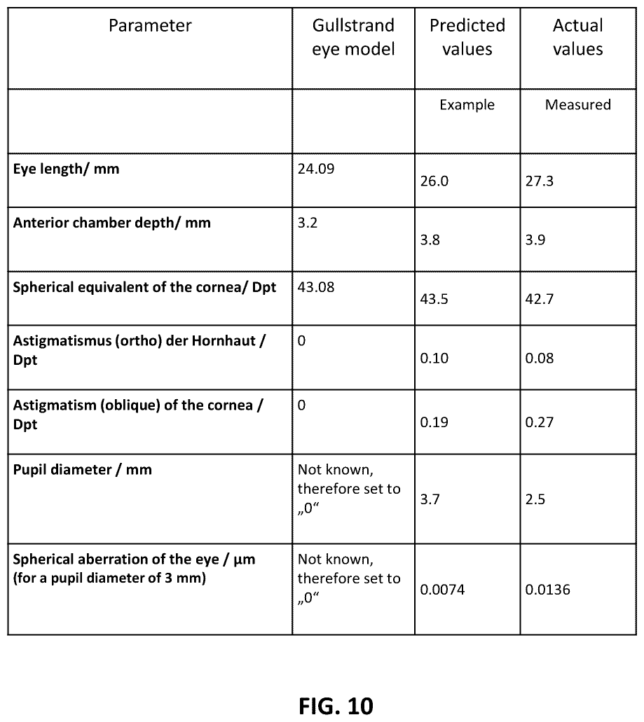

FIGS. 9 and 10 each show in tabular form different additional biometric parameters of the right eye (FIG. 9) and the left eye (FIG. 10) of a user with the following standard data:

### Right Eye:

Distance prescription:
   Sph=−3.00 dpt;
   Cyl=−1.75 dpt; Axis=173°;
Addition=0.00 dpt;
Pupillary distance PD=61.7 mm

### Left eye:

Distance prescription:
   Sph=−4.50 dpt;
   Cyl=−1.00 dpt; Axis=179°
Addition=0.00 dpt;
Pupillary distance PD=61.7 mm

Column 1 of the tables shown in FIGS. 9 and 10 indicates the values for the additional biometric parameters according to the Gullstrand eye model. Column 2 indicates the values for the additional biometric parameters determined using the method described above on the basis of a statistical model. The statistical model is a linear regression model such as shown in FIG. 3, which is modified for multiple tasks. Column 3 indicates actually measured values. The measured values were recorded using the “LenStar 900” (Haag-Streit) low-coherence reflectometer suitable for measuring the distances between the refracting surfaces of the eye.

As can be seen from FIGS. 9 to 10, the additional parameters calculated largely correspond to the parameters actually measured.

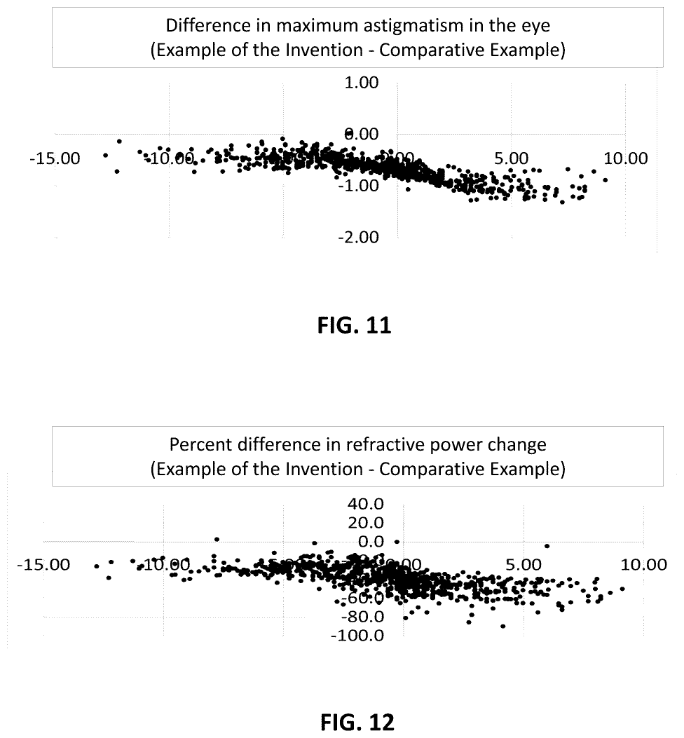

FIGS. 11 and 12 each show the differences in the properties of spectacle lenses (a total of 813 spectacle lenses), which have been calculated using a method according to an example of the invention, and conventional spectacle lenses without using a biometric model, which are based on biometric standard parameters such as those which the Gullstrand eye represents.

The mean power of the prescription (sph+cyl/2) in Dpt (also called spherical equivalent) is plotted on the abscissa of FIG. 11 and FIG. 12.

The difference [in Dpt] of the maximum astigmatism in the eye with a spectacle lens calculated using a method according to an example of the invention and the maximum astigmatism in the eye with a conventional spectacle lens is plotted on the ordinate of FIG. 11, with both spectacle lenses having the same standard parameters.

The percentage difference between the change in refractive power for a spectacle lens calculated by a method according to an example of the invention and the change in refractive power for a conventional spectacle lens is plotted on the ordinate of FIG. 12, with both spectacle lenses having the same standard parameters.

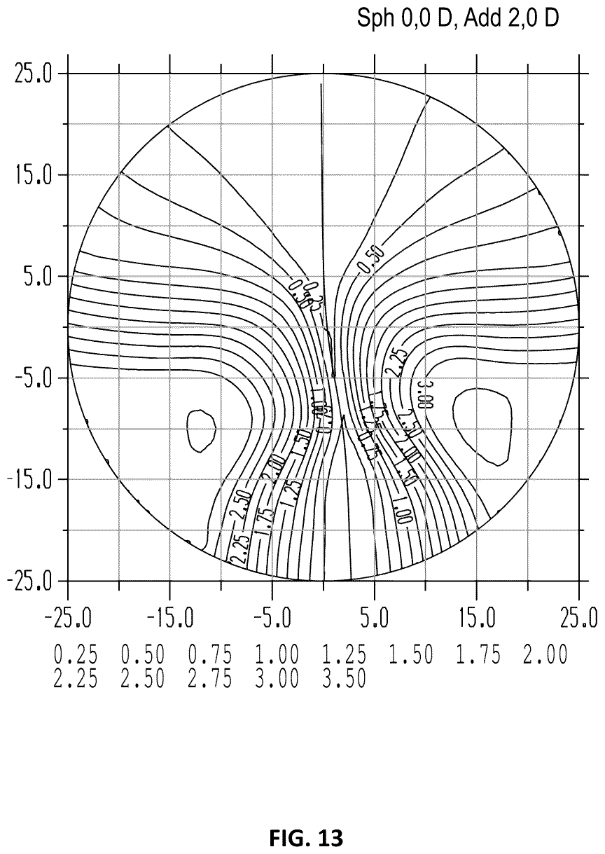

FIG. 13 shows the astigmatism in the image plane of a system spectacle lens-eye, the distance between two isoastigmatus lines being 0.25 Dpt. The spectacle lens was calculated using an exemplary method according to the invention for a distance prescription (Sph=0.0 Dpt, Ast=0.0 Dpt) and an addition Add=2.0 Dpt. The spectacle lens exhibits a reduction in maximum peripheral astigmatism (Cyl) of approximately 15%.

As can be seen from FIGS. 11 to 13, the spectacle lenses optimized on the basis of individual additional biometric parameters (additional data), wherein the additional data are calculated or predicted on the basis of standard data using a statistical model, have very good optical properties. A complex and cost-intensive measurement of individual additional data is therefore not required.

The exemplary method used in the calculation of the spectacle lenses with the values shown in FIGS. 11 to 13 will be described below.

The training data set includes about 20000 reference data sets. Each reference data set includes standard data and the additional data associated with the standard data. The standard data includes the prescription data (the distance prescription converted to M, J0, J45) of a user's right eye acquired by subjective refraction. The additional data includes the cornea topography in Zernike representation and the anterior chamber depth of the user's right eye. The training data set is used to train a linear regression model such as the model shown in FIG. 3.

The trained model enables a prediction of each of the Zernike coefficients c_{n,m}(x) of the cornea topography and the anterior chamber depth d_{CL}(x) as a linear regression of the following features:

$$x = {( 1 , M , {J}_{0} , {J}_{45} , Add , M \cdot {J}_{0} , M \cdot {J}_{45} , M \cdot Add , {J}_{0} \cdot {J}_{45} , {J}_{0} \cdot Add , {J}_{45} \cdot Add )}^{T} \qquad ( 5 )$$

In the linear regression model, it holds for the predicted Zernike coefficients c_{n,m}(x) of the cornea topography that:

$${c}_{n , m} ( x ) = {\sum }_{i} {a}_{n , m}^{i} {x}_{i} , \qquad ( 6 )$$

For the predicted anterior chamber depth d_{CL}(x) it holds that:

$${d}_{C L} ( x ) = {\sum }_{i} {a}_{C L}^{i} {x}_{i} , \qquad ( 7 )$$

In equations (6) and (7):
a_{n,m}ⁱ denotes the parameters of the linear regression of the i^{th} feature for predicting the Zernike coefficient c_{n,m}; and
a_{CL}ⁱ denotes the parameters of the linear regression of the i^{th} feature predicting the anterior chamber depth.

For the corneal vertex depth z as a function of the feature vector x and the position of the pupil coordinates Xₚᵤₚ, Yₚᵤₚ it holds that:

$$z ( x , {X}_{pup} , {Y}_{p u p} ) = {\sum }_{n , m} {c}_{n , m} ( x ) {Z}_{n , m} ( {X}_{p u p} , {Y}_{p u p} ) = {\sum }_{i} {x}_{i} {z}_{i} ( {X}_{pup} , {Y}_{p u p} ) , \qquad ( 8 )$$

where:

$${z}_{i} ( {X}_{pup} , {Y}_{p u p} ) = {\sum }_{n , m} {a}_{n , m}^{i} {Z}_{n , m} ( {X}_{pup} , {Y}_{p u p} ) \qquad ( 9 )$$

Z_{n,m}: denotes the (m,n)^{th} Zernike polynomial; and
Xₚᵤₚ, Yₚᵤₚ denote the pupil coordinates.

The terms of the sum according to equation (8) are determined by training the model.

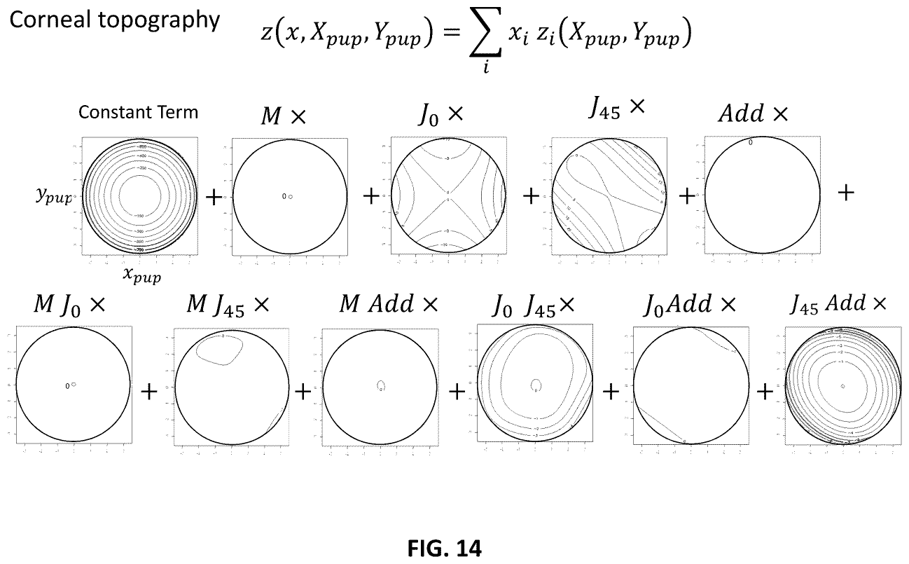

FIG. 14 shows a graphical representation of the trained model for corneal topography. As explained above, it holds for the vertex depth z of the corneal topography that:

$$z ( x , {X}_{pup} , {Y}_{p u p} ) = {\sum }_{i} {x}_{i} {z}_{i} ( {X}_{pup} , {Y}_{p u p} ) \qquad ( 10 )$$

In FIG. 14, the terms of the sum of equation (10) determined by training the model are shown as vertex depth plots, with the vertex depth isolines indicated in μm per unit of the respective feature (constant term, M, J₀, J₄₅, Add, M·J₀, M·J₄₅, M·Add, J₀·J₄₅, J₀·Add, J₄₅·Add) and the pupil coordinates Xₚᵤₚ, Yₚᵤₚ indicated in mm.

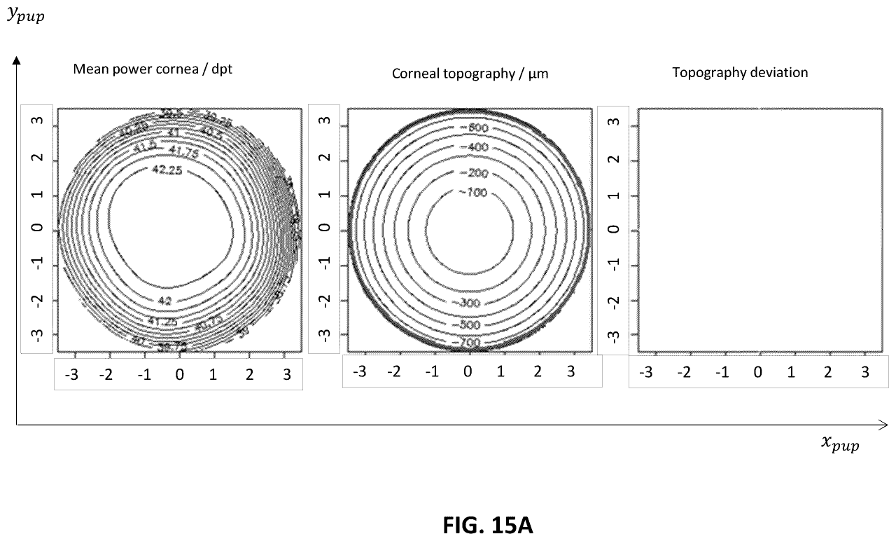

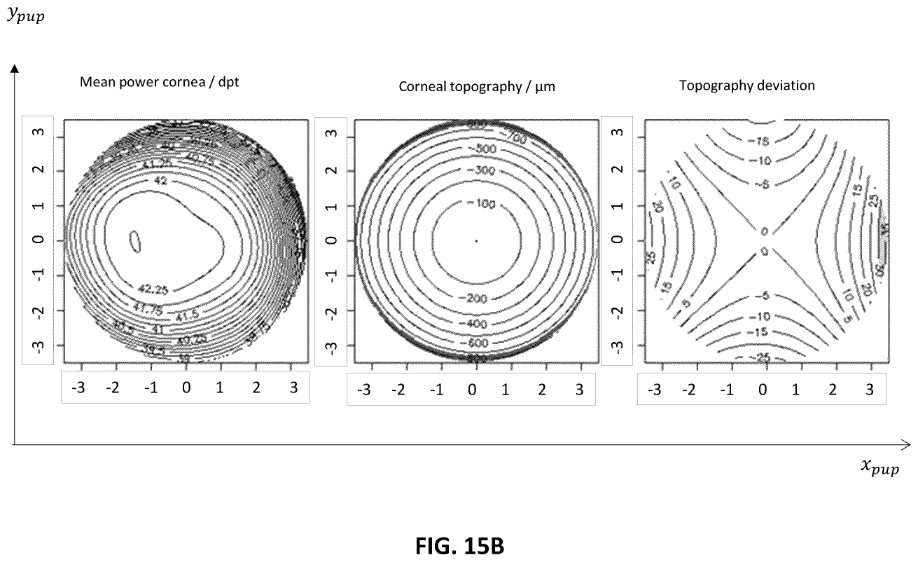

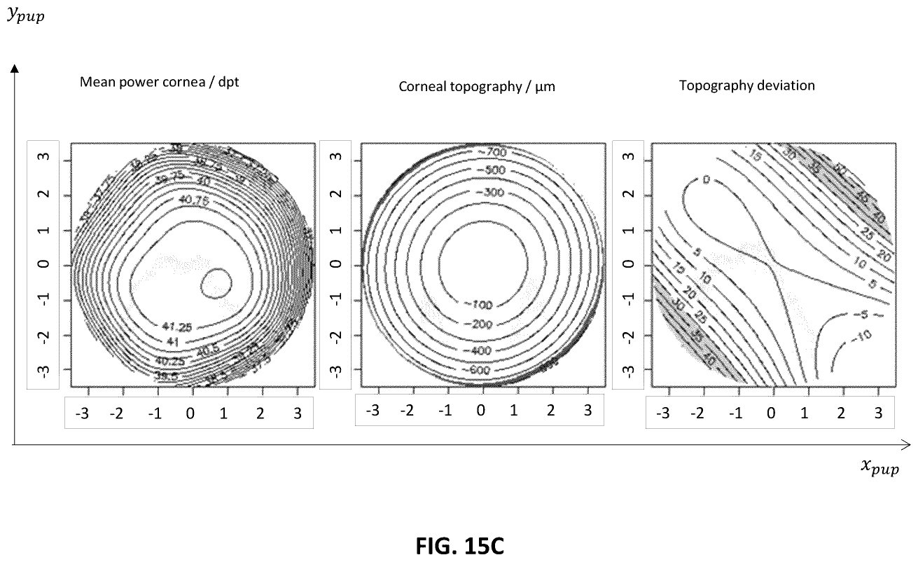

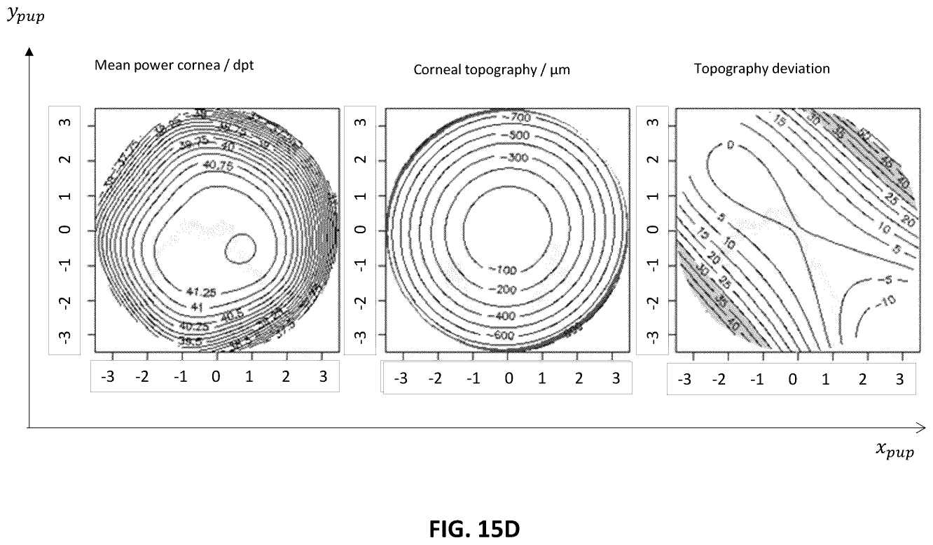

FIGS. 15A to 15D show exemplary predictions for the corneal topography based on the trained model with different standard parameters M (spherical equivalent), J0, J45 and Add. FIG. 15A shows the results (as isoline plots) for M=0 D, J0=0 D, J45=0 D and Add=0 D. FIG. 15B shows the results (as isoline plots) for M=0 D, J0=2 D, J45=0 D and Add=0 D. FIG. 15C shows the results (as isoline plots) for M=0 D, J0=0 D, J45=2 D and Add=0 D. FIG. 15D shows the results (as isoline plots) for M=0 D, J0=0 D, J45=0 D and Add=2 D. The pupil coordinates xₚᵤₚ, yₚᵤₚ are plotted on the abscissa and the ordinate in FIGS. 15A to 15D, respectively. In particular, FIGS. 15A to 15D each show, from left to right, the mean power of the cornea in Dpt, the corneal vertex depth (corneal topography) in μm, and the deviation of the corneal vertex depth from the constant term in the corneal topography representation according to equation (10) (topography deviation).

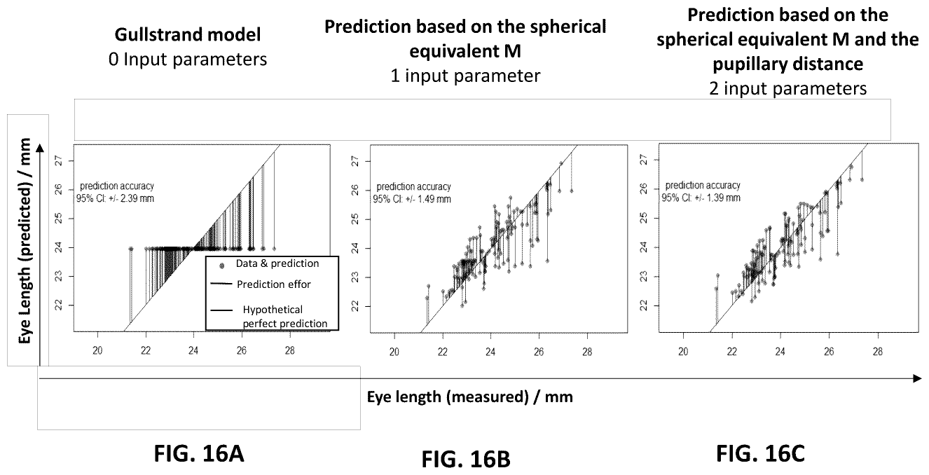

FIGS. 16A to 16C show the deviations of predicted additional data (in this case the eye length) from actually measured data. The measured eye length in mm is plotted on the abscissa. The predicted eye length is plotted in mm on the ordinate.

The predicted eye length shown in FIG. 16A is the eye length according to the Gullstrand eye model. This model has 0 input parameters. The accuracy of the prediction (95% confidence interval) is +/−2.4 mm.

The predicted eye length shown in FIG. 16B was determined using a trained statistical model with the spherical equivalent as an input parameter. The accuracy of the prediction (95% confidence interval) is +/−1.5 mm.

The predicted eye length shown in FIG. 16C was determined using a trained statistical model with the spherical equivalent and the pupillary distance as input parameters. The accuracy of the prediction (95% confidence interval) is +/−1.4 mm.

As can be seen from FIGS. 16A to 16C, considering multiple input parameters can improve the accuracy of the predictions.

### REFERENCE NUMERAL LIST

1 training data set
2 statistical model
10 reference data set
12 standard data
14 additional data
S1 to S5: method steps

1-13. (canceled)

14. A computer-implemented method for determining individual biometric parameters of at least one eye of a user, comprising:
providing individual standard data of the user, the standard data including prescription data including a distance prescription and/or a near prescription of the at least one eye of the user; and
calculating individual additional data including at least one individual biometric parameter of the at least one eye of the user based on the individual standard data and using a statistical model describing a relation between the standard data and the additional data,
wherein the statistical model has been derived using statistical analysis of a training data set with a plurality of reference data sets, each of the reference data sets including standard data and additional data associated with the standard data.

15. The method according to claim 14, further comprising:
providing the training data set; and
deriving the statistical model using statistical analysis of the training data set, wherein the deriving the statistical model comprises training an original model using the training data set.

16. The method according to claim 14, wherein the statistical model is a linear regression model, a nonlinear regression model, a non-parametric, or a semi-parametric regression model.

17. The method according to claim 14, wherein the statistical model is a neural network that has been trained using the training data set.

18. The method according to claim 14,
wherein the standard data further includes the addition and/or a pupillary distance and/or a pupil diameter.

19. The method according to claim 14,
wherein the additional data included in the reference data sets include biometric parameters that are not included in the standard data assigned to the additional data, and/or
wherein the additional data included in the reference data sets include biometric parameters that are included in the standard data assigned to the additional data, wherein values of the standard data and the additional data assigned to this standard data have been recorded with different measurement methods and/or measuring devices.

20. The method according to claim 14, wherein the prescriptions have been determined using subjective refraction.

21. The method according to claim 14, wherein the additional data included in the reference data sets include data that have been recorded with an aberrometer, a topographer, a Scheimpflug camera, an OCT, and/or a biometer.

22. The method according to claim 14, wherein the additional data include: lower and/or higher order aberrations of the at least one of the eyes, and/or anterior chamber depth and/or length of the at least one of the eyes, and/or lower and higher order aberrations of a cornea, and/or lower and/or higher order aberrations of an eye lens, and/or structure of the eye lens and/or curvature of the eye lens and/or thickness of the eye lens, and/or pupil sizes of the user during distance vision and near vision and/or under mesopic and photopic conditions.

23. A method for manufacturing a spectacle lens, comprising:
determining individual additional data including at least one individual biometric parameter of the at least one eye of the user based on the provided individual standard data of the user according to the method according to claim 14; and
calculating the spectacle lens based on the determined individual additional data.

24. A non-transitory computer program product which, when loaded into and executed on a memory of a computer, causes the computer to carry out the method according to claim 14.

25. A device for determining individual biometric parameters of at least one of the eyes of a user, the device comprising a calculator designed to carry out the method according to claim 14.

26. A device for manufacturing a spectacle lens, comprising:
a device designed to determine individual biometric parameters of the at least one eye of the user according to claim 25; and
a lens calculator designed to calculate the spectacle lens based on the calculated individual biometric parameters.
